(19) United States
(12) Patent Application Publication
(10) Pub. No.: US 2023/0139485 A1
(43) Pub. Date: May 4, 2023

(54) A Method of Deriviatizing a Highly Fluorinated Polymer with a Nonfluorinated Carbon-Carbon Double Bond, a Polymer Therefrom, and Curable Compositions Comprising the Polymer

(71) Applicant: 3M INNOVATIVE PROPERTIES COMPANY, St. Paul, MN (US)

(72) Inventors: Frans A. Audenaert, Kaprijke (BE); Leon M. Lillie, St. Paul, MN (US); Alain G. Verschuere, Melsele (BE)

(21) Appl. No.: 17/767,519

(22) PCT Filed: Dec. 11, 2020
(86) PCT No.: PCT/IB2020/061841

§ 371 Date: Apr. 8, 2022

Related U.S. Application Data
(60) Provisional application No. 62/948,447, filed on Dec. 16, 2019.

(51) Int. Cl. C09D 127/22; C08F 8/32; C08F 14/18

(52) U.S. Cl. CPC C09D 127/22; C08F 8/32; C08F 14/18

(57) ABSTRACT

Described herein is method of adding a non-fluorinated carbon-carbon double bond to a highly fluorinated polymer via an amidine linkage. In one embodiment, the derivatized fluorinated polymer comprising a highly fluorinated polymer backbone with pendent groups therefrom is disclosed, wherein at least one pendent group is according to the formula: (I) where Rf is a bond or a divalent perfluorinated group, optionally comprising at least one in-chain ether linkage, R is H, an alkyl group, or —CH(R″)X; R′ is H or an alkyl group; X is a monovalent group comprising at least one non-fluorinated carbon-carbon double bond; and R″ is H or an alkyl group. Such derivatized fluorinated polymers may be used in curable compositions and articles therefrom.

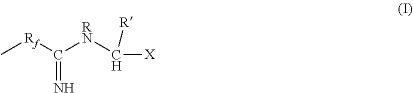

### TECHNICAL FIELD

A method of derivatizing a highly fluorinated polymer with a nonfluorinated carbon-carbon double bond is disclosed, along with the resulting derivatized fluorinated polymers. In one embodiment, such derivatized fluorinated polymers comprising a nonfluorinated carbon-carbon double bond can be cured with a free radical initiator system.

### SUMMARY

There is a desire to identify a novel way to introduce functionality into a highly fluorinated polymer. Such functionality can be useful, for example, to improve the heat aging stability, chemical resistance, and/or compression set of a cured fluoropolymer.

In one aspect, a method of reacting an olefinic group onto a highly fluorinated polymer to form a derivatized fluorinated polymer is disclosed. The method comprising:

contacting the highly fluorinated polymer, wherein the highly fluorinated polymer comprises at least one nitrile group with a reaction compound according to formula (I)

NH(R)—CH(R′)—X

where R is H, an alkyl group, or —CH(R″)X; R′ is H or an alkyl group; X is a monovalent group comprising at least one non-fluorinated carbon-carbon double bond; and R″ is H or an alkyl group.

In one embodiment, the contacting of the highly fluorinated polymer with the reaction compound is done in the presence of a non-aqueous liquid vehicle.

In another embodiment, the contacting of the highly fluorinated polymer with the reaction compound is done substantially free of an aqueous or non-aqueous vehicle.

In one aspect, a derivatized fluorinated polymer is disclosed comprising a highly fluorinated polymer backbone with pendent groups therefrom, wherein at least one pendent group is according to formula II:

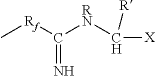

where Rf is a bond or a divalent perfluorinated group, optionally comprising at least one in-chain ether linkage; R is H, an alkyl group, or —CH(R″)X; R′ is H or an alkyl group; X comprises at least one non-fluorinated carbon-carbon double bond; and R″ is H or an alkyl group.

In yet another embodiment, a curable composition is disclosed. The curable composition comprising (i) a derivatized fluorinated polymer comprising a highly fluorinated polymer backbone with pendent groups therefrom is disclosed, wherein at least one pendent group is according to formula II:

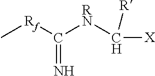

wherein Rf is a bond or a divalent perfluorinated group, optionally comprising at least one in-chain ether linkage; R is H, an alkyl group, or —CH(R″)X; R′ is H or an alkyl group; X comprises at least one non-fluorinated carbon-carbon double bond; and R″ is H or an alkyl group; and (ii) a peroxide curative.

In still another embodiment, an article comprising a fluoropolymer composition derived from a derivatized fluorinated polymer comprising a highly fluorinated polymer backbone with pendent groups therefrom, wherein at least one pendent group is according to formula II:

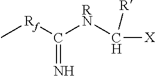

wherein Rf is a bond or a divalent perfluorinated group, optionally comprising at least one in-chain ether linkage; R is H, an alkyl group, or —CH(R″)X; R′ is H or an alkyl group; X comprises a non-fluorinated double bond; and R″ is H or an alkyl group; and a peroxide curative.

The above summary is not intended to describe each embodiment. The details of one or more embodiments of the invention are also set forth in the description below. Other features, objects, and advantages will be apparent from the description and from the claims.

### DETAILED DESCRIPTION

As used herein, the term

“a”, “an”, and “the” are used interchangeably and mean one or more; and

“and/or” is used to indicate one or both stated cases may occur, for example A and/or B includes, (A and B) and (A or B);

“backbone” refers to the main continuous chain of the polymer;

“crosslinking” refers to connecting two pre-formed polymer chains using chemical bonds or chemical groups;

“cure site” refers to functional groups, which may participate in crosslinking;

“interpolymerized” refers to monomers that are polymerized together to form a polymer backbone;

“monomer” is a molecule which can undergo polymerization which then form part of the essential structure of a polymer; and

“perfluorinated” means a group or a compound derived from a hydrocarbon wherein all hydrogen atoms have been replaced by fluorine atoms. A perfluorinated compound may however still contain other atoms than fluorine and carbon atoms, like oxygen atoms, nitrogen atoms, chlorine atoms, bromine atoms, and iodine atoms.

Also herein, recitation of ranges by endpoints includes all numbers subsumed within that range (e.g., 1 to 10 includes 1.4, 1.9, 2.33, 5.75, 9.98, etc.).

Also herein, recitation of “at least one” includes all numbers of one and greater (e.g., at least 2, at least 4, at least 6, at least 8, at least 10, at least 25, at least 50, at least 100, etc.).

As used herein, “comprises at least one of” A, B, and C refers to element A by itself, element B by itself, element C by itself, A and B, A and C, B and C, and a combination of all three.

In the present disclosure, a method for adding a nonfluorinated carbon-carbon double bond onto a highly fluorinated polymer is disclosed. Such derivatized fluorinated polymers may then be peroxide cured.

Derivatized Fluorinated Polymer

Derivatizing moieties comprising carbon-carbon double bonds into highly fluorinated polymers can be especially challenging due to the inherent lack of reactivity of perfluorinated groups.

Disclosed herein is a derivatized fluorinated polymer, comprising a highly fluorinated polymer backbone with at least one pendent group therefrom according to formula II:

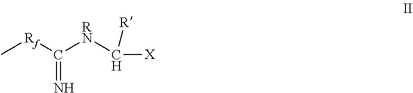

Where Rf is a bond or a divalent perfluorinated radical, optionally comprising at least one in-chain ether linkage; R is H, an alkyl group, or —CH(R″)X; R′ is H or an alkyl group; X comprises at least one non-fluorinated carbon-carbon double bond; and R″ is H or an alkyl group. In one embodiment, the highly fluorinated polymer is derivatized via a nucleophilic reaction between the amine of the reaction compound and the nitrile group of the highly fluorinated polymer to form an amidine linkage. The nitrile group may be present as an endgroup, where polymerization initiates or terminates, or as a side-chain, depending on how the nitrile group was incorporated into the polymer. Thus, as used herein, a pendent group refers to both side chains along the polymer backbone as well as endgroups located at the terminal ends of the polymer backbone.

When Rf is a divalent perfluorinated radical, Rf may be linear, branched, and/or cyclic in nature. In one embodiment, Rf comprises at least 1, 2, 3, or even 4 carbon atoms. In one embodiment, Rf comprises no more than 6, 8, 10, 12, 14, 16, or even 18 carbon atoms.

In one embodiment, Rf is a linear perfluorinated alkylene, such as —(CF2)n-, where n is an integer of at least 1, 2, 3, or even 4; and at most 5, 6, 7, or even 8. In one embodiment, Rf is a branched perfluorinated alkylene such as —[(CF2CF(CF3)]m)- or —[(CF(CF3)CF2]m)-, where m is an integer of at least 1, 2, 3, 4; and at most 5, 6, 7, or even 8.

In one embodiment, the divalent perfluorinated radical Rf may contain at least one in-chain oxygen atom. For example, Rf may comprise —(CF2)p-O—(CF2)q-, —(OCF2CF2)q-, —(OCF2CF(CF3))p-, —(OCF(CF3)CF2)p-, —(CF2CF(CF3))p-O—(CF2)q-, and/or —(CF(CF3)CF2)p-O—(CF2)q-, wherein p is an integer of 1, 2, 3, 4, 5, 6, 7, 8, 9, 10, or 11 and q is an integer from 1, 2, 3, 4, 5, 6, 7, 8, 9, 10, or 11, such that, if p and q are both present, the sum of p+q is from 2, 3, 4, 5, 6, 7, 8, 9, 10, 11, or 12.

In one embodiment, X is —(CH₂)ₙCH═CH₂ where n is 1, 2, 3, 4, 5, or 6, or —(CH₂)ₚCH═CH—(CH₂)_{q}—H, where p and q are independently 1 to 10.

The fluorinated polymers that can be derivatized with a pendent non-fluorinated carbon-carbon double bond, are discussed below. The pendent non-fluorinated carbon-carbon double bond is not reactive to the amidine formation and can be utilized during the curing of the fluorinated polymer and/or improve the properties of the resulting article.

In one embodiment, the derivatized fluorinated polymer comprises at least 5, 6, 8, 10, 12, 15, or even 20 carbon-carbon double bonds per polymer chain. In one embodiment, the derivatized fluorinated polymer comprises at most 25, 30, 40, 50, or even 100 carbon-carbon double bonds per polymer chain.

Method of Making

Disclosed herein is a process for making the derivatized fluorinated polymer disclosed above, wherein a reaction compound according to formula (I) is reacted with a highly fluorinated polymer, resulting in a fluorinated polymer comprising pendent carbon-carbon double bonds.

The reaction method disclosed herein is used for derivatizing highly fluorinated polymers. A highly fluorinated polymer has a majority of the C—H bonds of the polymer replaced with C—F bonds, for example at least 75, 80, or even 85% of the C—H bonds in the polymer are replaced by C—F bonds; and at most 90, 95, 99% or even 100% of the C—H bonds in the polymer are replaced by C—F bonds. In one embodiment, the highly fluorinated polymer is perfluorinated. A perfluorinated polymer, means that, excluding the sites where the polymerization initiates and terminates, the fluorinated polymer comprises no C—H bonds and the C—H bonds are primarily replaced with C—F bonds, and optionally includes other bonds, such as C—Br, C—I, or C—Cl bonds.

Typically, the highly fluorinated polymer is derived from one or more fluorinated monomer(s) such as TFE (tetrafluoroethylene), HFP (hexafluoropropylene), pentafluoropropylene, trifluoroethylene, CTFE (chlorotrifluoroethylene), perfluoro ethers, and combinations thereof.

Exemplary perfluoro ether monomers are of the Formula (III)

CF₂═CF(CF₂)ₕO(R_{f}^{c}O)ᵢ(R_{f}^{b}O)ⱼR_{f}^{a} (III)

where R_{f}^{b} and R_{f}^{c} are independently linear or branched perfluoroalkylene radical groups comprising 2, 3, 4, 5, or 6 carbon atoms, h is 0 or 1, i and j are independently an integer selected from 0, 1, 2, 3, 4, 5, 6, 7, 8, 9, and 10, and R^{a} is a perfluoroalkyl group comprising 1, 2, 3, 4, 5, or 6 carbon atoms. Exemplary perfluoroalkyl vinyl ether monomers include: perfluoro (methyl vinyl) ether (PMVE), perfluoro (ethyl vinyl) ether (PEVE), perfluoro (n-propyl vinyl) ether (PPVE-1), perfluoro-2-propoxypropylvinyl ether (PPVE-2), perfluoro-3-methoxy-n-propylvinyl ether, perfluoro-2-methoxy-ethylvinyl ether, perfluoro-methoxy-methylvinylether (CF₃—O—CF₂—O—CF═CF₂), and CF₃—(CF₂)₂—O—CF(CF₃)—CF₂—O—CF(CF₃)—CF₂—O—CF═CF₂. Exemplary perfluoroalkyl allyl ether monomers include: perfluoro (methyl allyl) ether (CF₂═CF—CF₂—O—CF₃), perfluoro (ethyl allyl) ether, perfluoro (n-propyl allyl) ether, perfluoro-2-propoxypropyl allyl ether, perfluoro-3-methoxy-n-propylallyl ether, perfluoro-2-methoxy-ethyl allyl ether, perfluoro-methoxy-methyl allyl ether, and CF₃—(CF₂)₂—O—CF(CF₃)—CF₂—O—CF(CF₃)—CF₂—O—CF₂CF═CF₂.

In one embodiment, the highly fluorinated polymers are substantially free of I, Br and/or Cl groups. In one embodiment, the fluorinated polymer comprises no more than 1, 0.5, 0.1, 0.05, or even 0.001% by weight or even no detectable amounts of I, Br, and Cl atoms versus the total weight of the highly fluorinated polymer.

In one embodiment, the fluorinated polymer is amorphous, meaning that there is an absence of long-range order (i.e., in long-range order the arrangement and orientation of the macromolecules beyond their nearest neighbors is understood). An amorphous fluoropolymer has no detectable crystalline character by DSC (differential scanning calorimetry), meaning that if studied under DSC, the fluoropolymer would have no melting point or melt transitions with an enthalpy more than 0.002, 0.01, 0.1, or even 1 Joule/g from the second heat of a heat/cool/heat cycle, when tested using a DSC thermogram with a first heat cycle starting at −85° C. and ramped at 10° C./min to 350° C., cooling to −85° C. at a rate of 10° C./min and a second heat cycle starting from −85° C. and ramped at 10° C./min to 350° C. Exemplary amorphous random copolymers may include: copolymers comprising TFE and perfluorinated vinyl ethers monomeric units (such as copolymers comprising TFE and PMVE, and copolymers comprising TFE and PEVE); copolymers comprising TFE and perfluorinated allyl ethers monomeric units; copolymers comprising VDF monomeric units as long as the copolymer is substantially free of —CH₂—CH₂— linkages; and combinations thereof. Exemplary copolymers comprising VDF monomeric units include copolymers comprising TFE, VDF, and HFP monomeric units; copolymers comprising CTFE and VDF monomeric units; copolymers comprising TFE and VDF monomeric units; copolymers comprising TFE, VDF and perfluorinated vinyl ethers monomeric units (such as copolymers comprising TFE, VDF, and PMVE) monomeric units; and copolymers comprising TFE, VDF, and perfluorinated vinyl ethers monomeric units (such as copolymers comprising TFE, VDF, and CF₂═CFO(CF₂)₃OCF₃) monomeric units.

The highly fluorinated polymer also comprises pendent nitrile (—C≡N) groups. In one embodiment, the highly fluorinated polymer comprises at least 5, 10, 15, 20, 25, 30, or even 35 nitrile groups per polymer chain. Typically, the highly fluorinated polymer should not comprise so many nitrile bonds that the cured derivatized polymer is too tightly crosslinked. In one embodiment, the highly fluorinated polymer comprises at most 25, 30, 40, 50, or even 100 carbon-carbon double bonds per polymer chain.

In one embodiment, the highly fluorinated polymer comprises at least 0.4, 0.5, 0.7, 1.0, 1.5, 2.0, or even 2.5% by weight of nitrile groups. In one embodiment, the highly fluorinated polymer comprises at most 2.0, 2.5, 3.0, 3.5, 4.0, 4.5, or even 5.0% by weight of nitrile groups.

These nitrile groups on the highly fluorinated polymer may be introduced through the use of nitrile-containing cure site monomers, which are introduced during the polymerization of the polymer as known in the art. Exemplary nitrile containing cure site monomers include CF₂═CFO(CF₂)_{L}CN wherein L is an integer from 2 to 12; CF₂═CFO(CF₂)ᵤOCF(CF₃)CN wherein u is an integer from 2 to 6; CF₂═CFO[CF₂CF(CF₃)O]_{q}(CF₂O)_{y}CF(CF₃)CN wherein q is an integer from 0 to 4 and r is an integer from 0 to 6; or CF₂═CF[OCF₂CF(CF₃)]ᵣO(CF₂)ₜCN wherein r is 1 or 2, and t is an integer from 1 to 4. Exemplary nitrile containing cure site monomers include CF₂═CFO(CF₂)₅CN, CF₂═CFOCF₂CF(CF₃)OCF₂CF₂CN, CF₂═CFOCF₂CF(CF₃)OCF₂CF(CF₃)CN, CF₂═CFOCF₂CF(CF₃)OCF₂CF₂CN, CF₂═CFOCF₂CF₂CF₂OCF(CF₃)CN, and CF₂═CFOCF(CF₃)OCF₂CF₂CN.

In one embodiment, the highly fluorinated polymer may be semi-crystalline. In one embodiment, the highly fluorinated polymer has a melting point below 150, 120, or even 100° C. In one embodiment, the highly fluorinated polymer has a melting point of at least 50, 60, or even 70° C.

In one embodiment, the highly fluorinated polymer comprises monomeric unit derived from TFE and HFP, and optionally a perfluorinated vinyl ether and/or perfluorinated allyl ether, along with a nitrile-containing compound as mentioned above. In one embodiment, the highly fluorinated polymer is derived from 10 to 20 mol % of a perfluorinated vinyl ether and/or perfluorinated allyl ether. In one embodiment, the highly fluorinated polymer is derived from 0.05 to 3 mol % of a nitrile cure site monomer as mentioned above.

In one embodiment, the highly fluorinated polymer has a number average molecular weight of at least 50000, 100000, or even 150000 Dalton; and at most 175000, 200000, 250000, 300000, 350000, 400000, or even 500000 Dalton. Typically, determination of the molecular weight of these polymers is difficult to do by gel permeation chromatography and therefore the molecular weight is determined based on viscosity, if amorphous, or melt flow index (MFI), if semi-crystalline.

In one embodiment, the highly fluorinated polymer has a Mooney viscosity (ML 1+10) at 121° C. of at least 1, 2, 5, 10, 15, or even 20; and at most 50, 60, 80, 100, 120, or even 140 when measured in a manner similar to that disclosed in ASTM D 1646-06. In one embodiment, the highly fluorinated polymer has an MFI (265° C./5 kg) from at least 1, 2, or even 3 g/10 min; and at most 1000, 500, or even 100 g/10 min.

Disclosed herein are two different methods for derivatizing the highly fluorinated polymer. One method utilizes a non-aqueous liquid vehicle and a second method is substantially free of a liquid vehicle.

In the first method, the highly fluorinated polymer is first dissolved in a non-aqueous liquid vehicle. In one embodiment, the non-aqueous liquid vehicle comprises less than 1, 0.5, 0.1, or even 0.05% by weight of water, or even no detectable amount of water.

Exemplary non-aqueous liquid vehicles (or solvents) include perfluorocarbons, hydrochlorofluorocarbons, hydrofluorocarbons, fluorinated ethers (such as perfluoropolyethers and hydrofluoroethers), fluorinated and non-fluorinated ketones (such as acetone, methyl ethyl ketone, methyl isobutyl ketone, methyl amyl ketone and), fluorinated and non-fluorinated amides (such as N-methyl-2-pyrrolidone and dimethylacetamide), fluorinated and non-fluorinated alkyl amines, fluorinated sulfones, non-fluorinated alcohols (such as methanol or ethanol), and non-fluorinated ethers such as tetrahydrofuran, 2-methyl tetrahydrofuran, and methyl tetrahydrofurfuryl ether. The solvents may be used alone or in combination with one another. When a non-fluorinated solvent is combined with a fluorinated solvent, the concentration of the non-fluorinated solvent is typically less than 30, 25, 20, 15, 10 or even 5 wt % with respect to the total amount of solvent.

The non-aqueous liquid vehicle used depends on the highly fluorinated polymer. For example, a fluorinated solvent (comprising C—F bonds) is appropriate for a perfluorinated polymer. If the highly fluorinated polymer comprises C—H bonds, a fluorinated or non-fluorinated solvent may be used depending on the degree of fluorination of the polymer and the solvent used. Generally, the more C—H bonds in the polymer, the less soluble the polymer will be in a perfluorinated solvent. One skilled in the art can determine whether or not the highly fluorinated polymer is dissolvable in the solvent, by adding an amount of the highly fluorinated polymer to the solvent, agitating and visually determining if the polymer is in solution.

In one embodiment, the solvent is a fluorinated ether solvent that is a partially fluorinated ether or a partially fluorinated polyether. The partially fluorinated ether or polyether may be linear, cyclic or branched. In one embodiment, the partially fluorinated ether or polyether corresponds to the formula: R1-O—R2 wherein R1 is a perfluorinated or partially fluorinated alkyl group that may be interrupted once or more than once by an ether oxygen and R2 is a non-fluorinated or partially fluorinated alkyl group, which may be linear, branched, or cyclic. Typically, R1 may have from 1 to 12 carbon atoms. R1 may be a primary, secondary or tertiary fluorinated or perfluorinated alkyl residue. This means when R1 is a primary alkyl residue the carbon atom linked to the ether atoms contains two fluorine atoms and is bonded to another carbon atom of the fluorinated or perfluorinated alkyl chain. In such case, R1 would correspond to R3-CF2- and the polyether can be described by the general formula: R3-CF2-O—R2, where R3 is a partially fluorinated or perfluorinated alkyl group that may be interrupted once or more than once by an ether oxygen. When R1 is a secondary alkyl residue, the carbon atom linked to the ether atom is also linked to one fluorine atom and to two carbon atoms of partially and/or perfluorinated alkyl chains and R1 corresponds to (Rf4Rf3)CF—. The polyether would correspond to (Rf4Rf3)CF—O—R. When R1 is a tertiary alkyl residue the carbon atom linked to the ether atom is also linked to three carbon atoms of three partially and/or perfluorinated alkyl chains and R1 corresponds to (Rf3Rf4Rf5)-C—. The polyether then corresponds to (Rf3Rf4Rf5)-C—OR, where Rf3; Rf4; and Rf5 are independently each a partially fluorinated or perfluorinated alkyl group that may be interrupted once or more than once by an ether oxygen; and R2 is a non-fluorinated or partially fluorinated alkyl group. The groups independently may be linear, branched, or cyclic. Also, a combination of polyethers may be used and also a combination of primary, secondary, and/or tertiary alkyl residues may be used.

An example of a solvent wherein R′ is a partially fluorinated alkyl group includes C₃F₇OCHFCF₃ (CAS No. 3330-15-2). An example of a solvent wherein R¹ is a polyether is C₃F₇OCF(CF₃)CF₂OCHFCF₃ (CAS No. 3330-14-1).

In some embodiments, the partially fluorinated ether solvent corresponds to the formula:

CₚF₂ₚ₊₁—O—C_{q}H_{2q+1}

wherein q is an integer from 1 to and 5, for example 1, 2, 3, 4 or 5, and p is an integer from 5 to 11, for example 5, 6, 7, 8, 9, 10 or 11. Preferably, CₚF₂ₚ₊₁ is branched. Preferably, CₚH₂ₚ₊₁ is branched and q is 1, 2 or 3.

Representative solvents include for example 1,1,1,2,2,3,4,5,5,5-decafluoro-3-methoxy-4-(trifluoromethyl)pentane and 3-ethoxy-1,1,1,2,3,4,4,5,5,6,6,6-dodecafluoro-2-(trifluoromethyl)hexane. Such solvents are commercially available, for example, under the trade designation “3M NOVEC ENGINEERED FLUID” from 3M Company, St. Paul, Minn.

In one embodiment, at least 5, 9, or even 10 wt % and at most 15, 18, 20, or even 25 wt % of the highly fluorinated polymer is dissolved in the non-aqueous liquid vehicle.

In a second method, the highly fluorinated polymer is reacted with the reactive compound in the absence of an aqueous or non-aqueous liquid vehicle. As used herein, substantially free of an aqueous or non-aqueous liquid vehicle, means that less than 2, 1, 0.5, 0.1, or even 0.05 wt % or even no detectable amount of a liquid vehicle is used when the highly fluorinated polymer and the reactive compound are contacted.

In the present disclosure, a non-fluorinated carbon-carbon double bond is derivatized onto the highly fluorinated polymer without undergoing reaction. The reaction compound comprises the non-fluorinated carbon-carbon double bond and a primary or secondary amine. The amine reacts with a nitrile group on the highly fluorinated polymer to form an amidine linkage, leaving the non-fluorinated carbon-carbon double bond intact.

In one embodiment, the reaction compound is of the structure NH(R)—CH(R′)—X Formula (I), where R, R′, R″ and X are the same as those disclosed above for Formula (II).

In one embodiment, the non-fluorinated carbon-carbon double bond is a terminal group, for example —CH═CH2. In another embodiment, the non-fluorinated carbon-carbon double bond is not terminal, for example —CH═CH—. In addition to the non-fluorinated carbon-carbon double bond, X may also comprise a fluorinated or non-fluorinated monovalent alkyl group, a fluorinated or non-fluorinated divalent alkylene group, an ether linkage a thioether linkage, a urea group, a urethane group, a carboxamide group, a sulfonamide group, and combinations thereof. Exemplary reaction compounds include: 4-aminostyrene (4-vinylaniline), CH2=CH(CH2)nNH2, and (CH2=CH—(CH2)n)₂NH where n is an integer from 1, 2, 3, 4, 5, or 6.

When utilizing the non-aqueous liquid vehicle, ideally, the reaction compound is soluble in the vehicle, meaning that when mixed in sufficient quantities in the solvent, the reaction compound does not phase separate with the solvent (in the case of a liquid) and that at least a portion of the reaction compound in solid form dissolves in the solvent. Typically, the reaction compound is non-gaseous, meaning that it is a liquid or solid at ambient conditions.

In one embodiment, the equivalent ratio of the amine in the reaction compound to the amount of —C≡N in the highly fluorinated polymer is at least 1:0.1 and at most 1:10. Preferably, the amount of amine in the reaction compound used is in excess of the amount of nitrile in the fluorinated polymer so that the reaction is favored.

The reaction mixture, comprising the highly fluorinated polymer, the reaction compound, and optionally the non-aqueous vehicle is then, for example, heated to initiate the formation of the amidine linkage. Typically, the reaction mixture is heated at temperatures of at least 30, 40, 50, or even 75° C. and at most 100, 110, or even 150° C. for at least 1, 2, 4, 6, or even 8 hours and at most 12, 16, 20, 24, 28, or even 36 hours. The reaction is typically conducted at ambient pressures.

The derivatized highly fluorinated polymer can then be cured using a free radical initiator to form a crosslinked fluoropolymer.

In one embodiment, the derivatization reaction and the crosslinking reaction can be combined in a one-pot step. For example, a free radical initiator is added to the reaction mixture comprising the highly fluorinated polymer and the reaction compound in a non-aqueous vehicle.

In this embodiment, the nitrile group and the amine react, while the free radical initiator initiates the radical formation and subsequently crosslinking of the non-fluorinated carbon-carbon double bonds. These reactions may occur in succession (with the derivatization reaction followed by crosslinking) or in tandem.

The free radical initiator includes those initiators known in the art.

In one embodiment, the free radical initiator includes peroxides such as organic peroxides. In many cases it is preferred to use a tertiary butyl peroxide having a tertiary carbon atom attached to a peroxy oxygen. Exemplary peroxides include: 2,5-dimethyl-2,5-di(t-butylperoxy)hexane; dicumyl peroxide; di(2-t-butylperoxyisopropyl)benzene; dialkyl peroxide; bis (dialkyl peroxide); 2,5-dimethyl-2,5-di(tertiarybutylperoxy)3-hexyne; dibenzoyl peroxide; 2,4-dichlorobenzoyl peroxide; tertiarybutyl perbenzoate; α,α′-bis(t-butylperoxy-diisopropylbenzene); t-butyl peroxy isopropylcarbonate, t-butyl peroxy 2-ethylhexyl carbonate, t-amyl peroxy 2-ethylhexyl carbonate, t-hexylperoxy isopropyl carbonate, di[1,3-dimethyl-3-(t-butylperoxy)butyl] carbonate, carbonoperoxoic acid, 0,0′-1,3-propanediyl 00,00′-bis(1,1-dimethylethyl) ester, and combinations thereof.

In one embodiment, the free radical initiator includes per-acids such as peracetic acid. Esters of the peracid can be used as well and examples thereof include tert-butylperoxyacetate and tert-butylperoxypivalate. A further class of initiators that can be used are azo-compounds. Suitable redox systems for use as initiators include, for example, a combination of peroxodisulphate and hydrogen sulphite or disulphite, a combination of thiosulphate and peroxodisulphate or a combination of peroxodisulphate and hydrazine. Further initiators that can be used are ammonium-alkali- or earth alkali salts of persulfates, permanganic or manganic acid or manganic acids, peresters or percarbonates.

The amount of free radical initiator used generally will be at least 0.03, 0.1, 0.2, 0.4, 0.6, 0.8, 1, 1.2, or even 1.5; at most 2, 2.25, 2.5, 2.75, 3, 3.5, 4, 4.5, 5, or even 5.5 parts by weight per 100 parts by weight of the highly fluorinated polymer or the derivatized highly fluorinated polymer.

Traditionally, coagents have been used in the peroxide curing of fluoroelastomers to improve the rate and/or state of the cure. Coagents are multifunctional molecules that can be categorized into Type I and Type II coagents. Type I coagents are typically polar, multifunctional low molecular weight compounds that forms very reactive radicals through additional reactions. Type I coagents include, for example acrylates and dimaleimides. Type II coagents are also multifunctional molecules which form less reactive radicals primarily through hydrogen abstraction. Type II coagents include, for example, allyl-containing cyanurates, allyl-containing isocyanurates and allyl-containing phthalates, homopolymers, and copolymers of dienes and vinyl aromatics (such as vinyl poly(butadiene) and vinyl styrene-butadiene copolymer). Exemplary coagents include: tri(methyl)allyl isocyanurate (TMAIC), triallyl isocyanurate (TAIC), tri(methyl)allyl cyanurate, poly-triallyl isocyanurate (poly-TAIC), triallyl cyanurate (TAC), xylylene-bis(diallyl isocyanurate) (XBD), N,N′-m-phenylene bismaleimide, diallyl phthalate, tris(diallylamine)-s-triazine, triallyl phosphite, 1,2-polybutadiene, ethyleneglycol diacrylate, diethyleneglycol diacrylate, zinc di(meth)acrylate, CH₂═CH—R_{f1}—CH═CH₂ wherein R_{f1} may be a perfluoroalkylene of 1 to 8 carbon atoms.

Unexpectedly, it has been discovered that the derivatized highly fluorinated polymers disclosed herein may be crosslinked with a free radical initiator such as a peroxide, in the absence of a coagent.

The curable compositions of the present disclosure comprise the derivatized highly fluorinated polymer (or a combination of the highly fluorinated polymer and the reactive compound) and the free radical initiator and the curable compositions and may or may not comprise a coagent as described above. In one embodiment, the curable compositions are substantially free of a coagent as described above, meaning the curable composition comprises less than 0.1, 0.075, 0.05, or even 0.01 wt % based on the weight of the highly fluorinated polymer or the derivatized polymer. In one embodiment there is no detectable coagent in the curable composition. Alternatively, in one embodiment, the curable compositions comprise a coagent as described above, for example, the curable composition comprises more than 0.1, 0.5, or even 1 wt %; and at most 2, 2.5, 3, 5, or even 8 wt % based on the weight of the highly fluorinated polymer or the derivatized polymer.

The curable compositions can also contain a wide variety of additives of the type normally used in the preparation of fluoropolymer compositions, such as acid acceptors, process aides, pigments, fillers, pore-forming agents, and those known in the art.

Such fillers include: an organic or inorganic filler such as clay, silica (SiO2), alumina, iron red, talc, diatomaceous earth, barium sulfate, wollastonite (CaSiO3), calcium carbonate (CaCO3), calcium fluoride, titanium oxide, iron oxide and carbon black fillers, a polytetrafluoroethylene powder, PFA (TFE/perfluorovinyl ether copolymer) powder, an electrically conductive filler, a heat-dissipating filler, and the like may be added as an optional component to the composition. Those skilled in the art are capable of selecting specific fillers at required amounts to achieve desired physical characteristics in the cured product. The filler components may result in a cured product that is capable of retaining a preferred elasticity and physical tensile, as indicated by an elongation and tensile strength value, while retaining desired properties such as retraction at lower temperature (TR-10).

In one embodiment, the curable composition and/or cured product comprises less than 40, 30, 20, 15, or even 10% by weight of the filler.

Conventional adjuvants may also be incorporated into the curable composition of the present disclosure to enhance the properties in the resulting cured product. For example, acid acceptors may be employed to facilitate the cure and thermal stability of the compound. Suitable acid acceptors may include magnesium oxide, lead oxide, calcium oxide, calcium hydroxide, dibasic lead phosphite, zinc oxide, barium carbonate, strontium hydroxide, calcium carbonate, hydrotalcite, alkali stearates, magnesium oxalate, or combinations thereof. The acid acceptors are preferably used in amounts ranging from at least 1, 2, 4, or even 5%; and at most 10, 15, or even 20% weight per weight of the highly fluorinated polymer or derivatized polymer.

In one embodiment, the curable compositions (and the resulting cured articles) are substantially free of inorganic acid acceptors, meaning that the curable composition (or resulting cured article) contains less than 0.5, 0.1, 0.05, 0.01% be weight per weight of the fluoropolymer, or even no inorganic acid acceptor.

One may choose between the two different derivatization methods depending on the application. If interested in a coating composition, the first method, wherein a non-aqueous liquid vehicle is used, may be advantageously straightforward. If interested in a solid material to extrude and/or mold into parts, the second method, substantially free of a liquid vehicle, maybe advantageous. However, the method selected is not limiting. For example, the derivatized polymer in the non-aqueous liquid vehicle may be dried down into a solid, which is then compounded and molded into parts.

In one embodiment, the derivatized fluorinated polymer is used in coating compositions. In one embodiment, the coating composition comprises the highly fluorinated polymer and the reactive compound in the non-aqueous liquid vehicle, with the free radical initiator. In another embodiment, the coating composition comprises the derivatized fluorinated polymer in a liquid vehicle and optionally includes the free radical initiator.

A solvent can be used to solubilize or disperse the derivatized highly fluorinated polymer so as to form a coating composition. Exemplary solvents include: those non-aqueous liquid vehicles as disclosed above, as well as solvents such as glycol ether, tetrahydrofuran, and combinations of solvents. In one embodiment, the solvent has a boiling point of at least 30, 40, 50, 80, or even 100° C.; and at most 120, 150, 200, 225, or even 250° C. In one embodiment, the solvent is used as a wetting agent, assisting in coating the surface of the substrate. The solvent may or may not be fluorinated and the solvent choice can be guided by the solubility of the fluorinated polymer before functionalization in the particular solvent. In one embodiment, the solvent used in the coating composition is a fluorinated ether as described above, such as 1-methoxyheptafluoropropane, methoxy-nonafluorobutane, and ethoxy-nonafluorobutane.

Ideally, the coating solution should use a solvent that has a low environmental impact, such as being a non-volatile organic compound (non-VOC), have short atmospheric lifetimes, and having a low global warming potential (GWP). In one embodiment, the solvent has a global warming potential (GWP) of less than 1000, 700, or even 500. In one embodiment, the solvent has atmospheric lifetime of less than 10 years, or even less than 5 years. See U.S. Prov. Pat. Appl. No. 62/671,500, filed 15 May 2018 for description of the GWP calculation and the Atmospheric Lifetime Test Method. See 40 CFR (Code of Federal Regulation) § 51.100(s) as of the date of filing for the definition of VOC, a listing of VOCs, and testing for compliance.

In one embodiment, the coating composition comprises at least 0.1, 0.2, 0.5, 1, 1.5, or even 2% by weight of the derivatized highly fluorinated polymer; and at most 5, 6, 8, 10, 12, 15, 18, or even 25% by weight of the derivatized highly fluorinated polymer.

For the purpose of, for example, enhancing the strength or imparting the functionality, conventional adjuvants, such as, for example, process aids (such as waxes, carnauba wax); plasticizers such as those available under the trade designation “STRUKTOL WB222” available from Struktol Co., Stow, Ohio; fillers; and/or colorants may be added to the composition.

Such fillers include: an organic or inorganic filler such as clay, alumina, iron red, talc, diatomaceous earth, barium sulfate, calcium carbonate (CaCO₃), calcium fluoride, titanium oxide, boron nitride, and iron oxide, a polytetrafluoroethylene powder, PFA (TFE/perfluorovinyl ether copolymer) powder, an electrically conductive filler, a heat-dissipating filler, and the like may be added as an optional component to the coating composition.

In one embodiment, carbon black is added to the composition. Carbon black fillers are typically employed as a means to balance modulus, tensile strength, elongation, hardness, abrasion resistance, conductivity, and processability of polymer compositions. Suitable examples include MT blacks (medium thermal black) designated N-991, N-990, N-908, and N-907; FEF N-550; and large particle size furnace blacks. When used, 1 to 100 parts by weight of large size particle black filler per hundred parts by weight of the derivatized fluorinated polymer is generally sufficient.

In one embodiment, the composition comprises less than 40, 30, 20, 15, or even 10% by weight of the filler per hundred parts by weight of the derivatized fluorinated polymer.

The coating compositions may be prepared by mixing the derivatized fluorinated polymer, the solvent, the peroxides, and optional additives.

In one embodiment, the coating composition comprises at least 5, 10, 20, 25, or even 30% solids and at most 40, 50, 60 or even 70% solids based on weight. However, for thinner coatings, the coating composition may comprise at least 0.5, 1, 2, or even 2.5% solids and at most 3, 4, 5, or even 6% solids based on weight.

The coating compositions of the present disclosure may be coated onto substrates, such as inorganic and organic substrates. Exemplary inorganic substrates include, glass, ceramic, glass ceramic, or metals such as carbon steel (e.g., high-carbon steel, stainless steel, aluminized steel), stainless steel, aluminum, aluminum alloys, and combinations thereof. Exemplary organic substrates include, polyvinyl chloride, polycarbonate, polyterephthalate, polyamide, olefinic substrates (such as polyethylene and polypropylene), and combinations thereof.

In the present disclosure, the substrate may be smooth or roughened. In one embodiment, the substrate is treated before use. The substrate may be chemically treated (e.g., chemical cleaning, etching, etc.) or abrasively treated (e.g., grit blasting, microblasting, waterjet blasting, shot peening, ablation, or milling) to clean or roughen the surface prior to use.

Bonding agents and primers may be used to pretreat the surface of the organic or inorganic substrate before coating. For example, bonding of the coating to metal surfaces may be improved by applying a bonding agent or primer, such as an amino-silane or alkoxysilane. Exemplary amino-silanes include primary, secondary or tertiary amino-functional compounds according to secondary or tertiary amino-functional compound is represented by formula (R³)₂N—R¹—[Si(Y)ₚ(R²)₃₋ₚ]_{q} wherein R¹ is a multivalent alkylene group optionally interrupted by one or more ether linkages or up to three amine (—NR³—) groups; R² is alkyl or arylalkylenyl; each R³ is independently hydrogen, hydroxy, alkyl, hydroxyalkyl, arylalkylenyl hydroxyarylalkylenyl, or —R¹—[Si(Y)ₚ(R²)₃₋ₚ]; Y is alkoxy, acyloxy, aryloxy, polyalkyleneoxy, halogen, or hydroxyl; p is 1, 2, or 3; and q is 1, 2, or 3, with the provisos that at least two independently selected —Si(Y)p(R²)₃₋ₚ groups are present and that both R³ groups may not be hydrogen, as disclosed in US Pat. Publ. Nos. 2017-0081523 (Audenaert) and 2018-0282578 (Audenaert et al.), herein incorporated by reference. In some embodiments, such alkoxy silanes may be characterized as “non-functional” having the chemical formula:

R²Si(OR¹)ₘ

wherein R¹ is independently a multivalent alkylene group optionally interrupted by one or more ether linkages or up to three amine (—NR³—) groups;
R² is independently hydrogen, alkyl, aryl, alkaryl, or OR¹ wherein R¹ is a multivalent alkylene group optionally interrupted by one or more ether linkages or up to three amine (—NR³—) groups; and
m is 1, 2, or 3, and is typically 2 or 3.

Suitable alkoxy silanes of the formula R2Si(OR1)m include, but are not limited to tetra-, tri- or dialkoxy silanes, and any combinations or mixtures thereof. Representative alkoxy silanes include propyltrimethoxysilane, propyltriethoxysilane, butyltrimethoxysilane, butyltriethoxysilane, pentyltrimethoxysilane, pentyltriethoxysilane, heptyltrimethoxysilane, heptyltriethoxysilane, octyltrimethoxysilane, octyltriethoxysilane, dodecyltrimethoxysilane, dodecyltriethoxysilane, hexadecyltrimethoxysilane, hexadecyltriethoxysilane, octadecyltrimethoxysilane, octadecyltriethoxysilane, phenyltrimethoxysilane, phenyltriethoxysilane dimethyldimethoxysilane and dimethyldiethoxysilane.

Preferably, the alkyl group(s) of the alkoxy silanes comprises from 1 to 6, more preferably 1 to 4 carbon atoms. Preferred alkoxysilanes for use herein are selected from the group consisting of tetra methoxysilane, tetra ethoxysilane, methyl triethoxysilane, dimethyldiethoxysilane, and any mixtures thereof. A preferred alkoxysilane for use herein comprises tetraethoxysilane (TEOS). The alkoxy silane lacking organofunctional groups utilized in the method of making the coating composition may be partially hydrolyzed, such as in the case of partially hydrolyzed tetramethoxysilane (TMOS) available from Mitsuibishi Chemical Company under the trade designation “MS-51”.

Examples of commercial primers or bonding agents, include, for example those available under the trade designation CHEMLOK 5150 and CHEMLOK 8116, available from Lord Corp., Cary, N.C. In one embodiment, the articles of the present disclosure, do not comprise a primer between the substrate and the derivatized fluorinated polymer composition.

The substrate may be imbibed or coated with the coating solution as disclosed herein using conventional techniques known in the art, including but not limited to, dip coating, roll coating, painting, spray coating, knife coating, gravure coating, extrusion, die-coating, and the like. The coating may be colored in cases where the compositions contains pigments, for example titanium dioxides or black fillers like graphite or soot, or it may be colorless in cases where pigments or black fillers are absent.

After coating, the solvent may be advantageously reduced or completely removed, for example by evaporation, drying or by boiling the solvent away from the sample. The coated sample can be heated at temperatures of room temperature or even higher, for example up to 100° C. or even 180° C. to remove solvent, depending on the solvent and the substrate used.

Typically, the coated sample is dried at room temperature and/or heated to bond the fluoropolymer composition to the substrate and cure the derivatized fluorinated polymer. In one embodiment, the coated sample is heated at a temperature of at least 75, 80, 90, 100, 120, or even 130° C.; and at most 150, 200, 220, 250 or even 300° C., for a period of at least 2, 5, 10, 15, 30, or even 60 minutes; and at most 2, 5, 10, 15, 24, 36, or even 48 hours depending on the cross-sectional thickness of the coating. For thick sections of coating, the temperature during the heating step is usually raised gradually from the lower limit of the range to the desired maximum temperature. In some embodiments, processing of the coated article is carried out by conveying the coated article through an oven with an increasing temperature profile from entrance to exit.

When performing an in situ reaction and cure for coatings (in other words, coating a substrate comprising a solution containing the highly fluorinated polymer, the reaction compound according to formula (I) and a peroxide, among other things), it may, in one embodiment, be advantageous to perform a drying step at a lower temperature before activating the cure. In one embodiment, a drying step that is at least 40, 50 or even 60° C. lower than the cure temperature is performed before the curing step. For example, a coated solution may be dried at 100° C. and then cured at 140° C. Such a process may ensure that crosslinking is occurring between polymer chains and not the reaction compounds. wherein the pre-drying step is for example 100° C. and the cure is at 140° C.

In one embodiment, the cured coating is at least 12, 15, 20, 25, 50, or even 100 micrometers thick; and at most 500, 1000, or even 2000 micrometers thick. In one embodiment, the cured coating is a thin coating with a thickness of at least 20, 30, 40, 50, 75, or even 100 nanometers (nm); and at most 120, 150, 200, 500, 750, or even 1000 nm thick.

The curable fluoropolymer compositions may be prepared by mixing the desired components in conventional rubber processing equipment to provide a solid mixture, i.e. a solid polymer containing the additional ingredients, also referred to in the art as a “compound”. This process of mixing the ingredients to produce such a solid polymer composition containing other ingredients is typically called “compounding”. Such equipment includes rubber mills, internal mixers, such as Banbury mixers, and mixing extruders. The temperature of the mixture during mixing typically will not rise above about 120° C. During mixing, the components and additives are distributed uniformly throughout the resulting fluoropolymer “compound” or polymer sheets. The “compound” can then be extruded or pressed in a mold, e.g., a cavity or a transfer mold and subsequently be oven-cured. In an alternative embodiment, curing can be done in an autoclave.

Pressing of the compounded mixture (i.e., press cure) is typically conducted at a temperature of about 120-220° C., preferably about 140-200° C., for a period of about 1 minute to about 15 hours, usually for about 1-15 minutes. A pressure of about 700-20,000 kPa, preferably about 3400-6800 kPa, is typically used in molding the composition. The molds first may be coated with a release agent and prebaked.

The molded product can be post cured in an oven at a temperature of about 140-240° C., preferably at a temperature of about 160-230° C., for a period of about 1-24 hours or more, depending on the cross-sectional thickness of the sample. For thick sections, the temperature during the post cure is usually raised gradually from the lower limit of the range to the desired maximum temperature. The maximum temperature used is preferably about 260° C., and is held at this value for about 1 hour or more.

The cured highly fluorinated polymer is particularly useful as hoses, seals, gaskets, and molded parts in automotive, chemical processing, semiconductor, aerospace, and petroleum industry applications, among others.

In one embodiment, the cured compositions disclosed herein have improved heat stability, for example as compared to cured non-derivatized compositions.

In one embodiment, the cured compositions disclosed herein have improved chemical stability for example as compared to cured non-derivatized compositions. For example, as shown in the examples, wherein the uncured polymer dissolves in the fluorinated solvent, but the cured polymer is not.

### EXAMPLES

Unless otherwise noted, all parts, percentages, ratios, etc. in the examples and the rest of the specification are by weight, and all reagents used in the examples were obtained, or are available, from general chemical suppliers such as, for example, Sigma-Aldrich Company, Saint Louis, Mo., or may be synthesized by conventional methods.

The following abbreviations are used in this section: cm=centimeter, g=grams, min=minutes, h=hours, ° C.=degrees Celsius, FT-IR=Fourier Transform infrared spectrometry, wt %=weight percent, L=liters, ml=milliLiters, MHz=mega Hertz, rpm=revolutions per minute, phr=parts per hundred rubber, and DSC=differential scanning calorimetry.

Test Methods and Procedures:

Nuclear Magnetic Resonance (NMR) spectroscopy:

Proton NMR spectra was run on a 300 MHz NMR from Bruker Corp., Billerica, Mass.

Mooney Viscosity

Mooney viscosities were determined in accordance with ASTM D1646-07(2012), a 1-minute pre-heat and a 10-minute test at 121° C. (ML 1+10 at 121° C.).

Cure Rheology

For Examples 7 through 10 and Comparative Examples 1 through 4, cure Rheology tests were run on uncured, compounded admixtures using a Moving Die Rheometer (MDR) (available under the trade designation “MDR 2000” Alpha Technologies, Akron, Ohio) in accordance with ASTM D 5289-95 at 177° C., no preheat, 15 minutes elapsed time (unless otherwise specified) and a 0.5° arc. Minimum torque (ML), Maximum torque (MH), i.e., highest torque attained during specified period of time when no plateau or maximum was obtained was reported. Also reported were: t′50 (time for torque to reach ML+0.5 (MH-ML)), and t′90 (time for torque to reach ML+0.9 (MH-ML)).

For Example 16 and Comparative Examples 8 and 10, cure rheology tests were carried out using uncured, compounded samples using a rheometer marketed under the trade designation PPA 2000 by Alpha technologies, Akron, Ohio, in accordance with ASTM D 5289-93a at 188° C., no pre-heat, 12 or 15 minutes elapsed time and a 0.5 degree arc. Both the minimum torque (ML) and the maximum torque (MH) were measured in units of inch·pounds and converted to deciNewton·meters (dN·m). If no plateau or maximum torque was obtained, the highest torque attained during the specified period of time was reported as MH. The time for the torque to reach a value equal to ML+0.1 (MH−ML), (t′10), the time for the torque to reach a value equal to ML+0.5 (MH−ML), (t′50), and the time for the torque to reach ML+0.9 (MH−ML), (t′90) were also measured. The ratio of the viscous torque over the elastic torque were determined at the minimum and maximum torque and are reported as the tan 6.

Compression Set Testing

O-rings (214, AMS AS568) were molded at 188° C. for 15 minutes. O-rings were then post-cured at 232° C. for 20 hours. The post-cured O-rings were subjected to compression set testing for 70 hours at 200° C. and 250° C. in accordance with ASTM D 395-03 Method B and ASTM D 1414-94 with an initial deflection of 25 percent. Results, shown in Table 4, are reported in percentages.

Materials

| Name | Description |
|---|---|
| Allyl alcohol | CH2═CH—CH2—OH, available from Sigma-Aldrich |
| Allyl amine | CH2═CH—CH2—NH2, available from Sigma-Aldrich |
| Diallyl amine | (CH2═CH—CH2)2—NH, available from Sigma-Aldrich |
| 3-Buten-1ol | CH2═CH—CH2CH2—OH, available from Sigma-Aldrich |
| FP1 | An amorphous Fluoropolymer 1, prepared according to procedures |
| | described in U.S. Pat. No. 8,604,137 (Grootaert et al.) having 65.8 |
| | mol % TFE, 32.9 mol % PMVE and 0.27w % nitrile groups |
| FP2 | An amorphous Fluoropolymer 2, prepared according to procedures |
| | Described in U.S. Pat. No. 8,604,137 (Grootaert et al.) having 63 |
| | mol % TFE and 34.4 mol % PMVE and 0.57w % nitrile groups |
| HFE-7300 | 3-methoxyperfluoro(2-methylpentane) hydrofluoroether available |
| | under the trade designation “3M NOVEC 7300 ENGINEERED FLUID” |
| | from 3M Co., Maplewood, MN |
| HFE-7500 | 3-ethoxyperfluoro(2-methylhexane) hydrofluoroether available under |
| | the trade designation “3M NOVEC 7500 ENGINEERED FLUID” |
| | from 3M Co. |
| FC-72 | Perfluorohexane, available under the trade designation “3M |
| | FLUORINERT ELECTRONIC LIQUID FC-72” from 3M Co. |
| FC-3283 | Perfluorotripropylamine, “3M FLUORINERT ELECTRONIC |
| | LIQUID FC-3283” from 3M Co. |
| Initiator 1 | tert-Butyl peroxybenzoate initiator (98%) available under the trade |
| | designation “LUPEROX P” from Sigma-Aldrich |
| Initiator 2 | 2,5-dimethyl-2,5-di(tert-butylperoxy)hexane initiator on an inert |
| | (silica) filler, available under the trade designation “VAROX |
| | DBPH-50” from Vanderbilt Chemicals, LLC, Norwalk, CT |
| TAIC 1 | Triallyl isocyanurate, available under the trade designation |
| | “LUVOMAXX TAIC” from Lehmann&Voss&Co KG, Hamburg, |
| | Germany |
| TAIC 2 | Triallyl isocyanurate, available under the trade designation |
| | “TAIC DLC-A” (72%) from Natrochem, Inc., Savannah, GA |

Preparation of Stock Solutions of Fluoropolymers in Fluorinated Solvents

For the synthesis of the allyl and diallyl derivatized fluoropolymers, fluoropolymer raw gum was first dissolved in a fluorinated solvent as given in the examples, by charging small pieces of the raw gum and fluorinated solvent into a 500 ml bottle and shaking on a Lab-Shaker (available from Adolf Kihner AG, Switzerland) at 250 rpm until a homogeneous solution was obtained. This solution is further referred to as ‘stock solution’.

### Examples EX-1 to EX-3: Synthesis of Derivatized Fluoropolymers

In example EX-1, a 100 ml reaction bottle was charged with 235.29 g of an 8.5 wt % stock solution of FP1 in FC-72, 0.52 g allylamine and 174.66 g FC-72 to obtain a 5% solids solution. The mixture was put on a laboratory bottle roller for 16 hr at room temperature. Full conversion of the nitrile-function to amidine-groups was confirmed by FT-IR where an amidine signal was observed at 1656-1658 cm−1 while the CN-absorption (at approximately 2263 cm−1) disappeared.

The excess allylamine and solvent were removed with a Büchi rotary evaporator using waterjet vacuum for 1 hr at 85° C., followed by oil pump vacuum for 1 hr at 85° C., yielding white elastomeric polymer solids, further referred to as Allyl-FFP1

In example EX-2, allyl derivatized fluoropolymer 2 (Allyl-FFP2) was prepared essentially according to the same procedure for EX-1, starting from an 8.5 wt % stock solution of FP2 in FC-72 (instead of FP1 in FC-72) and allyl amine. The excess allylamine and solvent were removed as given for Allyl-FFP1.

In example EX-3, diallyl derivatized fluoropolymer 1 (Diallyl-FFP1) was prepared essentially according to the same procedure for EX-1, but using diallyl amine instead of allyl amine. The reaction was done at 8 wt % solids and the mixture was reacted for 20 hrs at 75° C. in a pre-heated Launder-O-meter. Full conversion of the nitrile-function to amidine-groups was confirmed by FT-IR where the amidine signal was observed at 1615-1618 cm−1, while the CN-absorption (at approximately 2263 cm−1) disappeared. The excess diallylamine and solvent were removed as given for Allyl-FFP1.

Examples EX-4 to EX-6: Derivatized fluorinated polymer in solvent

In example EX-4, a 100 ml reaction bottle was charged with 90.91 g of a 5.5 wt % stock solution of FP1 in FC-3283, 0.13 g allylamine and 11.58 g FC-3283. The sealed bottle was run for 6 hrs in a Launder-O-meter at 75° C. at which point full conversion of the nitrile-function to amidine-groups was confirmed by FT-IR. An almost clear semi-viscous solution containing allyl derivatized FP1 was obtained. This solution is further referred to as Allyl-FFPIS.

In examples EX-5 and EX-6, solutions of diallyl derivatized FP1 (Diallyl-FFPIS) and allyl derivatized FP2 (Allyl-FFP2S) in FC-3283 were prepared essentially according to the same procedure as EX-1 starting from respectively a 5.5 wt % stock solution of FP1 (in FC-3283) and diallylamine or a 5.5 wt % stock solution of FP-2 (in FC-3283) and allylamine.

### Examples EX-7 to EX-10 and Comparative Examples C-1 to C-4

In examples EX-7 to EX-10 the curing behavior of the derivatized fluoropolymers was evaluated. In a first step, stock solutions were prepared by charging small pieces of the derivatized fluoropolymers and HFE-7300 into a bottle and shaking on a Lab-Shaker at 250 rpm until a homogeneous solution was obtained. The stock solutions used in EX-7 and EX-8 were prepared from respectively Allyl-FFP1 and Allyl-FFP2 at 5 wt % solids. The stock solutions used in EX-9 and EX-10 contained 4 wt % Diallyl-FFP1. Comparative examples C-1 and C-3 were made from a 5.5 wt % stock solution of FP1 in HFE-7300. Comparative examples C-2 and C-4 were made from 5.5 wt % stock solutions of FP2 in HFE-73000.

Initiator 1 (0.75% on solids) was added to the solutions of examples EX-7 to EX-9 and comparative examples C-1 and C-3. The mixtures were put on a lab roller for 1 hour.

Initiator 1 (0.75% on solids) and TAIC 1 (1.5% on solids) were added to the solutions of EX-10, C-2 and C-4. Theses mixtures were put on a lab roller for 16 hrs.

After evaporating the HFE-7300 solvent with a Büchi rotary evaporator, using waterjet vacuum (1 hr at 40° C.), the curing behavior of the compositions was evaluated on an MDR instrument as given above.

The results of the measurement are listed in table 1

TABLE 1
Curing behavior of the derivatized fluoropolymers

| | Sample | | | | | | | |
|---|---|---|---|---|---|---|---|---|
| | EX- | EX- | EX- | EX- | C- | C- | C- | C- |
| | 7 | 8 | 9 | 10 | 1 | 2 | 3 | 4 |
| ML (dN · m) | 1.7 | 1.2 | 2.1 | 2.1 | 0.92 | 0.41 | 1.3 | 0.72 |
| MH (dN · m) | 5.9 | 5.6 | 7.6 | 9.8 | 2.0 | 1.5 | 6.8 | 6.4 |
| t′50 (min) | 0.45 | 0.45 | 0.57 | 0.49 | 0.9 | 0.86 | 0.54 | 0.55 |
| t′90 (min) | 0.63 | 0.81 | 1.49 | 0.76 | 1.79 | 1.75 | 0.87 | 0.88 |

### Examples EX-11 to EX-13 and Comparative Examples C-5 and C-6

In Examples EX-11 to EX-13, curable coating formulations were prepared. In a first step, stock solutions were prepared from allyl derivatized fluoropolymers (used in EX-11 to EX-13) and fluoropolymers (used in comparative examples C-5 and C-6) as described above.

Initiator 1 (0.75% on solids) and FC-3283 were added to the stock solutions. The mixtures were put on a lab roller for 1 hr to obtain homogeneous mixtures at 5% solids.

Coatings were prepared by pipetting about 10 g coating formulation (containing 0.5 g solids) in an aluminum dish (˜50 cm2), covered with a siliconized PET film.

The coatings were immediately cured at 140° C. during 15 min, optionally followed by post cure at 180° C. during 15 min. The cured coatings had a theoretical thickness of about 50 micrometers (taking into account a fluoropolymer density of ˜2.0 g/cm3).

Then 0.25 g cured coating and 12.25 g HFE-7300 were added to a 20 ml vial and shaken at 250 rpm for 16 hrs.

Solubility was rated visually as ‘dissolved’, ‘partially dissolved’ or ‘not dissolved’:
A completely dissolved coating indicated that no crosslinking occurred during the curing process
A partially dissolved coating indicated that partial crosslinking occurred during the curing process
A coating that did not dissolve indicated that full crosslinking occurred during the curing process
   The results are summarized in table 2.

TABLE 2
Coatings prepared from (di)allyl derivatized fluoropolymers

| Example | Formulation | Post cure | Solubility in HFE-300 |
|---|---|---|---|
| Ex-11 | Allyl-FFP1S | no | Dissolved |
| | | yes | Not dissolved |
| Ex-12 | Diallyl | no | Partially dissolved |
| | FFP1S | | (gels observed) |
| | | yes | Not dissolved |
| Ex-13 | Allyl | no | Dissolved |
| | FFP2S | yes | Not dissolved |
| C-5 | FP1 | no | Dissolved |
| | | yes | Dissolved |
| C-6 | FP2 | no | Dissolved |
| | | yes | Dissolved |

### Examples EX-14 and EX-15 and Comparative Examples C-7 and C-8

In examples EX-14 and EX-15 coating formulations of fluoropolymers, having cure site monomers with a nitrile-group, were in situ crosslinked by adding allylamine and peroxy-initiator (initiator 1). No TAIC was added. Therefore, 5% solids solutions of FP1 and Initiator 1 (0.75% in solids) in HFE-7300 were prepared by mixing on a lab roller for 1 hr to obtain a homogeneous mixture. EX-14 and EX-15 were made by adding 5 equivalents of allyl amines or diallyl amine respectively. Comparative examples C-7 and C-8 were prepared the same way, but allyl alcohol or butenol were added respectively instead of (di)allyl amine.

All mixtures were manually shaken for 30 seconds and then immediately coated as outlined above in examples EX-11 to EX 13. The coatings were dried for 24 hours at 50° C., followed by 2 hours at 80° C. Curing was done for 15 min at 140° C., optionally followed by post curing at 180° C. The results are listed in table 3.

TABLE 3
In situ cure of fluorinated polymers with allyl amines and peroxide

| Example | Curative | Post cure | Solubility in HFE-7300 |
|---|---|---|---|
| Ex-14 | Allyl amine | no | Not Dissolved |
| | | yes | Not dissolved |
| Ex-15 | Diallyl amine | no | Not dissolved |
| | | yes | Not dissolved |
| C-7 | Allyl alcohol | no | Dissolved |
| | | yes | Dissolved |
| C-8 | 3-buten-1-ol | no | Dissolved |
| | | yes | Dissolved |

The same experiment was repeated without the drying step. In this case, the coating of EX-14 only partially dissolved when cured for 15 min at 140° C. The coating did not dissolve after additional post cure at 180° C. for 15 min. All other coatings (EX-15 and comparative examples C-7 and C-8) dissolved in HFE-7300 when the drying step was omitted, independent of the curing, indicating that that fluorinated polymers containing nitrile groups can also be peroxy cured (crosslinked) in-situ with allyl and diallyl amine at 140° C., preferably when a lower temperature pre-drying step is used to allow reaction of the amines with the nitrile group.

Preparation of Compounded Fluoropolymers

### Example 16

FP1 (50 grams, 100 phr) was banded on a two-roll mill. Diallyl amine (0.6 g, 1.2 phr) was added dropwise to the banded polymer gum and mixed until uniform. Initiator 2 (0.375 g, 0.75 phr) was added as solid to the banded mixture and mixed until uniform.

### Comparative 9

FP1 (50 grams, 100 phr) was banded on a two-roll mill. Initiator 2 (0.375 g, 0.75 phr) was added as solid to the banded mixture and mixed until uniform.

### Comparative 10

FP1 (50 grams, 100 phr) was banded on a two-roll mill. TAIC 2 (1.25 g, 2.5 phr) was added as a powder to the banded polymer gum and mixed until uniform. Initiator 2 (0.375 g, 0.75 phr) was added as solid to the banded mixture and mixed until uniform.

TABLE 4
Formulations, cure rhology, and compression set results

| | units | Ex-16 | C-9 | C-10 |
|---|---|---|---|---|
| Ingredient | | phr | phr | phr |
| PFE 131 | | 100 | 100 | 100 |
| Diallylamine | | 1.2 | | |
| DBPH-50 | | 0.75 | 0.75 | 0.75 |
| TAIC (72% DLC) | | | | 2.5 |
| Test Time | min | 12 | 12 | 15 |
| Test Temp | ° C. | 188 | 188 | 188 |
| ML | lb-in | 1.15 | 0.86 | 0.89 |
| | dN-m | 1.30 | 0.97 | 1.00 |
| MH | lb-in | 7.74 | 2.47 | 6.84 |
| | dN-m | 8.74 | 2.79 | 7.73 |
| t′10 | min | 0.66 | 1.16 | 0.51 |
| t′50 | min | 1.24 | 2.27 | 0.82 |
| t′90 | min | 3.47 | 7.07 | 2.11 |
| tanD@MH | | 0.072 | 0.364 | 0.13 |
| tanD@ML | | 0.887 | 1 | 1.146 |
| Compression Set (CS) | | | | |
| (%), 25% Deflection, | | | | |
| ASTM D395-18 | | | | |
| Method B, 70 h@200° C. | | | | |
| Press Cure time | min | 15 | NT | 15 |
| @188° C. | | | | |
| CS, Post Cure, 20 hr | | 35.8 | NT | |
| @232° C. | | | | |
| CS, Post Cure, 16 hr | | | | 72.9 |
| @232° C. | | | | |
| Compression Set (%), | | | | |
| 25% Deflection, ASTM | | | | |
| D395-18 Method B, | | | | |
| 70 h@250° C. | | | | |
| Press Cure time | min | 15 | NT | 15 |
| @188° C. | | | | |
| CS, Post Cure, 20 hr | | 56.5 | NT | |
| @232° C. | | | | |
| CS, Post Cure, 16 hr | | | | 97.1 |
| @232° C. | | | | |

NT = not tested

Foreseeable modifications and alterations of this invention will be apparent to those skilled in the art without departing from the scope and spirit of this invention. This invention should not be restricted to the embodiments that are set forth in this application for illustrative purposes. To the extent that there is any conflict or discrepancy between this specification as written and the disclosure in any document mentioned or incorporated by reference herein, this specification as written will prevail.

1. A method of reacting an olefinic group onto a highly fluorinated polymer to form a derivatized fluorinated polymer, the method comprising:
contacting the highly fluorinated polymer wherein the highly fluorinated polymer comprises at least one nitrile group with a reaction compound according to formula (I)
NH(R)—CH(R′)—X
Where R is H; an alkyl group, or —CH(R″)X; R′ is H or an alkyl group; X is a monovalent group comprising at least one non-fluorinated carbon-carbon double bond; and R″ is H or an alkyl group.

2. The method of claim 1, wherein the amine is a primary amine.

3. The method of claim 1, wherein X comprises a terminal or non-terminal carbon-carbon double bond.

4. The method of claim 1, wherein formula (I) is -aminostyrene (4-vinylaniline), CH₂═CH(CH₂)ₙNH₂, and (CH₂═CH—(CH₂)ₙ)₂NH where n is an integer from 1 to 6.

5. (canceled)

6. (canceled)

7. The method of claim 1, wherein the highly fluorinated polymer comprises at least 0.4% to at most 5% by weight of nitrile groups versus the total weight of the highly fluorinated polymer.

8. (canceled)

9. The method of claim 1, wherein the highly fluorinated polymer is dissolved in a non-aqueous vehicle.

10. (canceled)

11. The method of claim 9, wherein the non-aqueous vehicle comprises at least one of a perfluorinated alkane, a perfluorinated amine, a perfluorinated ether, and a hydrofluoroether.

12. The method of claim 1, wherein the highly fluorinated polymer is compounded with the reaction compound.

13. The method of claim 1, wherein contacting the highly fluorinated polymer with the reaction compound is done substantially free of an aqueous and non-aqueous vehicle.

14. The method of claim 1, comprising an equivalent ratio of the amine in the reaction compound to the nitrile group of 1:0.1 to 1:10.

15. A derivatized fluorinated polymer comprising a perfluorinated polymer backbone with pendent groups therefrom, wherein at least one pendent group is according to formula: 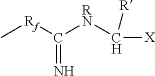
where Rf is a bond or a divalent perfluorinated group, optionally comprising at least one in-chain ether linkage, R is H, an alkyl group, or —CH(R″)X; R′ is H or an alkyl group; X comprises at least one non-fluorinated carbon-carbon double bond; and R″ is H or an alkyl group.

16. The derivatized fluorinated polymer of claim 15, wherein X is —(CH2)nCH═CH2 where n is an integer from 1-6.

17. The derivatized fluorinated polymer of claim 15, wherein the derivatized fluorinated polymer comprises interpolymerized tetrafluoroethylene monomeric units.

18. The derivatized fluorinated polymer of claim 15, wherein the derivatized fluorinated polymer comprises interpolymerized perfluoro ether monomeric units.

19. (canceled)

20. The derivatized fluorinated polymer of claim 15, wherein the derivatized fluorinated polymer comprises at least 5 nonfluorinated carbon-carbon double bonds.

21. A curable composition comprising the derivatized fluorinated polymer of claim 15 and a peroxide curative.

22. (canceled)

23. (canceled)

24. (canceled)

25. A coating composition comprising the derivatized fluorinated polymer of claim 15 and a peroxide curative in a non-aqueous vehicle.

26. A coating composition comprising a highly fluorinated polymer in a non-aqueous vehicle, wherein the highly fluorinated polymer comprises at least one nitrile group; a reaction compound according to formula (I)
NH(R)—CH(R′)—X
where R is H; an alkyl group, or —CH(R″)X; R′ is H or an alkyl group; X is a monovalent group comprising at least one non-fluorinated carbon-carbon double bond; and R″ is H or an alkyl group; and a peroxide curative.

27. The coating composition according to claim 25, wherein the non-aqueous vehicle is a fluorinated solvent.

28. (canceled)

29. (canceled)

30. (canceled)

31. (canceled)

32. An article comprising a fluoropolymer composition derived from the derivatized fluorinated polymer according to claim 15 and a peroxide curative.

33. (canceled)
